(19) United States
(12) Patent Application Publication
(10) Pub. No.: US 2007/0229367 A1
(43) Pub. Date: Oct. 4, 2007

(54) Antenna apparatus

(75) Inventors: Shinji Fukui, Okazaki-city (JP); Yuzi Sugimoto, Kariya-city (JP); Taizou Mizutani, Nagoya-city (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-city (JP)

(21) Appl. No.: 11/729,433

(22) Filed: Mar. 28, 2007

(30) Foreign Application Priority Data
Mar. 31, 2006 (JP) 2006-098547

(51) Int. Cl. H01Q 1/38

(52) U.S. Cl. 343/700 MS; 343/846

(57) ABSTRACT

An antenna apparatus has a ground and an antenna element. The antenna element includes a feeding portion and two turnback potions. The two turnback portions are on different radial lines, which originate from the feeding point to depart from each other on a surface of the antenna element. The two turnback portions are individually coupled with the ground via connection portions to thereby form two loops starting from the feeding portion and returning to the ground. A high dielectric member is provided as having a predetermined thickness and a surface identical to the surface of the ground and opposing the ground face-to-face. Therefore, the high frequency electric current applied to the feeding portion turns back at the turnback portions to return to the ground via the connection portions while forming two current loops.

### CROSS REFERENCE TO RELATED APPLICATION

This application is based on and incorporates herein by reference Japanese Patent Application No. 2006-98547 filed on Mar. 31, 2006.

### FIELD OF THE INVENTION

The present invention relates to an antenna apparatus used in a UWB (Ultra Wide Band) communication system to achieve a wideband wireless communications with a high data transmission rate.

### BACKGROUND OF THE INVENTION

An antenna apparatus used in a UWB (Ultra Wide Band) communications system is disclosed in Non-patent document 1. This antenna apparatus includes two large and small oval elements as an antenna element (i.e., a radiation element), and an inverted U-letter element as a substitute for a ground. The large oval element has a hole approximately as large as the small oval element. The two oval elements are connected with a central conductor of a coaxial cable; the inverted U-letter element is connected with an outer conductor of the coaxial cable.

Non-Patent document 1: NEC Gihou (technical report) Vol. 58 No. 2/2005

In the antenna apparatus, the two oval elements and inverted U-letter element are formed as a conductive plate or a conductor pattern on a printed circuit board. This allows the antenna apparatus shaped of a flat plate and facilitates an installation of the apparatus within a housing of an instrument. However, the antenna apparatus only uses a mono-pole antenna technology. This does not sufficiently respond to a requirement of downsizing the antenna.

### SUMMARY OF THE INVENTION

It is an object of the present invention to provide an antenna apparatus to allow a wideband wireless communications system with a high data transmission rate and a reduction in the size of the housing thereof.

According to an aspect of the present invention, an antenna apparatus is provided as follow. A ground shaped of a flat plate is included. An antenna element shaped of a flat plate is included. A surface of the ground and a surface of the antenna element are approximately on a plane. An antenna element includes a feeding portion and at least two turnback portions. The at least two turnback portions are on different radial lines, which originate from the feeding point to depart from each other on the surface of the antenna element. The at least two turnback portions are individually coupled with the ground via connection portions to thereby form at least two loops, which individually link the feeding portion with the ground.

According to an additional aspect, the above antenna apparatus may be provided as follows. A high dielectric member is further included as having a predetermined thickness and a surface parallel with the plane. The surface of the high dielectric member has a shape approximately identical to a shape of the surface of the ground. The high dielectric member is thereby configured to oppose the ground face-to-face.

### BRIEF DESCRIPTION OF THE DRAWINGS

The above and other objects, features, and advantages of the present invention will become more apparent from the following detailed description made with reference to the accompanying drawings. In the drawings:

FIG. 1 is an oblique front view of an antenna apparatus according to a first embodiment of the present invention;

FIG. 2 is an oblique rear view of the antenna apparatus in FIG. 1;

FIG. 3 is a view illustrating a feeding portion and grounding portion of the antenna apparatus in FIG. 1;

FIG. 4 is a diagram illustrating VSWR measurement results from the antenna apparatus in FIG. 1;

FIG. 5 is an oblique front view of an antenna apparatus according to a second embodiment of the present invention;

FIG. 6 is an oblique front view of an antenna apparatus according to a third embodiment of the present invention;

FIG. 7 is an oblique front view of an antenna apparatus according to a fourth embodiment of the present invention;

FIG. 8 is an oblique front view of an antenna apparatus according to a fifth embodiment of the present invention;

FIG. 9 is a diagram illustrating VSWR measurement results from the antenna apparatus in FIG. 8;

FIG. 10 is an oblique front view of an antenna apparatus according to a sixth embodiment of the present invention;

FIG. 11 is an oblique front view of an antenna apparatus according to a seventh embodiment of the present invention;

FIG. 12 is an oblique rear view of the antenna apparatus in FIG. 11;

FIG. 13 is an oblique front view of an antenna apparatus according to an eighth embodiment of the present invention;

FIG. 14 is an oblique front view of an antenna apparatus according to another embodiment of the present invention; and

FIG. 15 is an oblique front view of an antenna apparatus according to yet another embodiment of the present invention.

### DETAILED DESCRIPTION OF THE PREFERRED EMBODIMENTS

### First Embodiment

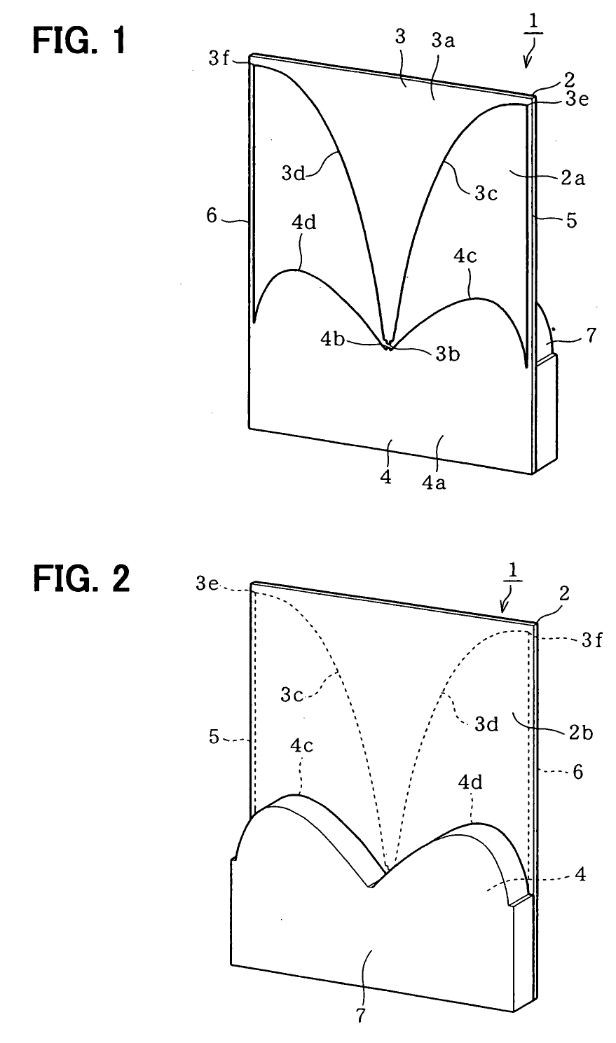

The present invention is adapted to an antenna apparatus provided in an in-vehicle device such as a navigation apparatus or an in-vehicle monitor apparatus. An antenna apparatus as a first embodiment will be explained with reference to FIGS. 1 to 4. The antenna apparatus 1 includes a dielectric substrate 2 shaped of a flat plate. On the front side 2a of the substrate 2, an antenna element 3 is formed in an upper portion, a ground 4 is formed in a lower portion, and connection portions 5, 6 are formed along the left and right ends. Those are formed using copper foil patterns as conductor patterns. Here, an antenna element surface 3a is defined as a surface (i.e., a planar or flat surface area) of the antenna element 3; a ground surface 4a is defined as a surface (i.e., a planar or flat surface area) of the ground 4. The antenna element surface 3a and the ground surface 4a are positioned approximately on an identical plane.

The antenna element 3 has a feeding portion 3b in a central bottom portion thereof, two parabola portions 3c, 3d, and two turnback portions 3e, 3f. The two parabola portions 3c, 3d are formed as approximately bilaterally-symmetric parabolas each starting from the feeding portion 3b to one of the two turnback portions 3e, 3f positioned in upper corner portions of the substrate 2. The turnback portions 3e, 3f are individually coupled to the ground 4 via the connection portions 5, 6. The ground 4 has two parabola portions 4c, 4d formed as approximately bilaterally-symmetric parabolas each laterally extending from a grounding portion 4b (closely opposing the feeding portion 3b). In contrast, on the rear side 2b of the dielectric substrate 2, a high dielectric member 7 is formed to have a predetermined thickness and a surface shaped identically to the ground surface 4a. Thus, the high dielectric member 7 and the ground 4 oppose each other face-to-face with the dielectric substrate 2 intervening therebetween.

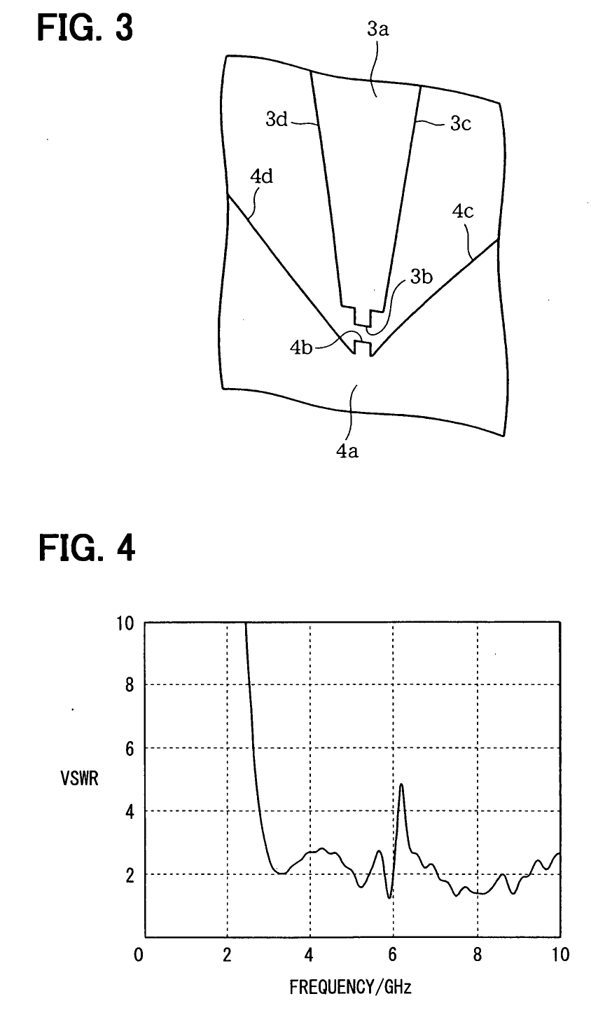

As shown in FIG. 3, the feeding portion 3b protrudes towards the ground 4, while the grounding portion 4b protrudes towards the antenna element 3. For instance, a coaxial cable (not shown) can be connected with the feeding portion 3b at the central conductor; the coaxial cable can be connected with the grounding portion 4b at an outer conductor. It may be alternatively designed that a coplanar line feeds high frequency electric power.

In the above configuration, when a high frequency electric power is fed to the feeding portion 3b, the high frequency electric current applied to the feeding portion 3b flows along the parabola portions 3c, 3d, turns back at the turnback portions 3e, 3f, and returns to the ground 4 via the connection portions 5, 6 while forming two current loops. In other words, each of two loops is configured to link, in a series, (i) the feeding portion 3b, (ii) one of the turnback portions 3e, 3f, which are on different radial lines positioned on the antenna element surface 3a and starting from the feeding portion 3b to thereby depart from each other, (iii) one of the connection portions 5, 6, and (iv) the ground 4. Therefore, this configuration comes to approximately accord with that of an antenna apparatus, which combines a discone antenna and two loop antennas on a two-dimensional plane. In particular, the two loop antennas parallel connected with each other constitute a double-loop antenna. FIG. 4 shows measurement results on VSWR (Voltage Standing Wave Ratio) of the antenna apparatus 1, exhibiting a preferable characteristic in 3.1 GHz or more, which is used for communications.

Thus, in the first embodiment, the antenna apparatus 1 is provided to achieve a wideband characteristic and a wideband wireless communications system with a high data transmission rate. Further, the high dielectric member 7 is provided to have a predetermined thickness and a surface shaped identical to the ground surface 4a such that the high dielectric member 7 opposes the ground 4 face-to-face. This provides an effect to decrease a wavelength, reducing the size of the ground 4 and the size of the antenna apparatus 1 itself as well.

### Second Embodiment

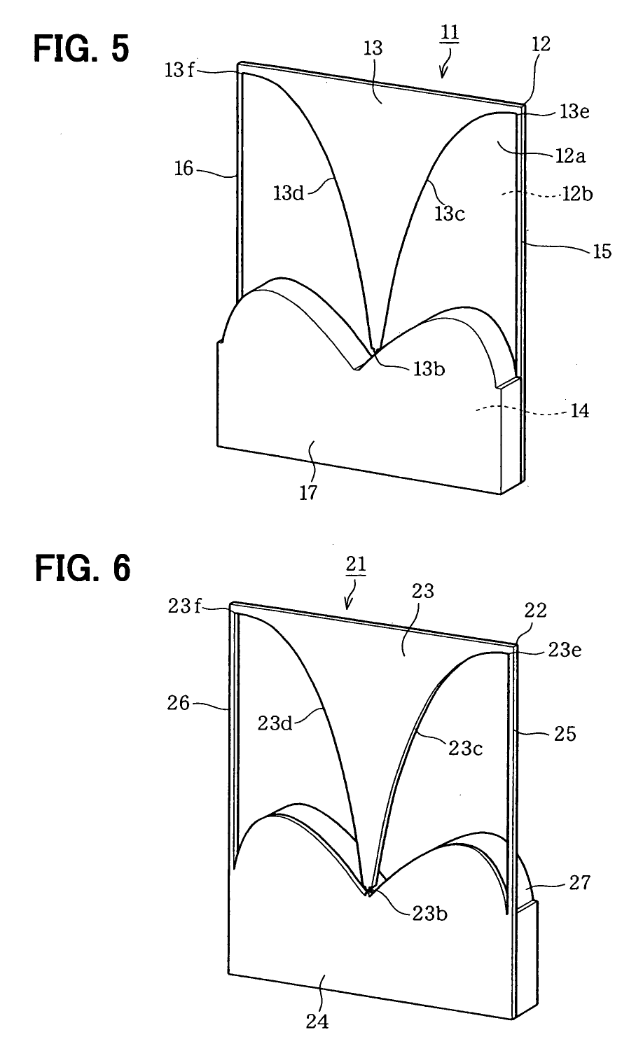

A second embodiment of the present invention will be explained with reference to FIG. 5. Parts identical to those of the first embodiment are not explained; different part will be explained below. In the second embodiment, positions of the ground 4 and the high dielectric member 7 are alternate between the first embodiment (in FIG. 1) and second embodiment (in FIG. 5) The antenna apparatus 11 includes a dielectric substrate 12 shaped of a flat plate. On the front side 12a of the substrate 12, an antenna element 13 is formed in an upper portion, and connection portions 15, 16 are formed along the left and right ends. Those are formed using copper foil patterns. Further, on the front side 12a, a high dielectric member 17 is formed in a lower portion to have a predetermined thickness and a surface shaped identically to that of a ground 14. On the rear side 12b of the dielectric substrate 12, the ground 14 is formed in a lower portion using a copper foil pattern. The connection portions 15, 16 are connected with the ground 14 through a via-hole (VIA).

In the above configuration, when a high frequency electric power is fed to a feeding portion 13b, the high frequency electric current applied to the feeding portion 13b flows along parabola portions 13c, 13d, turns back at turnback portions 13e, 13f, and returns to the ground 14 via the connection portions 15, 16 and the VIA while forming two current loops. Thus, in the second embodiment, similarly to the first embodiment, the antenna apparatus 11 is provided to achieve a wideband characteristic and a wideband wireless communications system with a high data transmission rate. This also provides an effect to decrease a wavelength to allow reductions in the sizes of the ground 14 and the antenna apparatus 11 itself.

### Third Embodiment

A third embodiment of the present invention will be explained with reference to FIG. 6. Parts identical to those of the first embodiment are not explained; different part will be explained below. In the third embodiment, an antenna element, a ground, and connection portions are made of conductive plates instead of copper foil patterns. In an antenna apparatus 21, a rectangular conductive plate 22 is provided to have two cut areas to thereby form an antenna element 23 in an upper portion, a ground 24 in a lower portion, and connection portions 25, 26 along two lateral ends. Further, a high dielectric member 27 is formed to have a predetermined thickness and a surface shaped identically to that of the ground 24 such that the high dielectric member 27 abuts to all the surface of the ground 24.

In the configuration, the antenna element 23, ground 24, connection portions 25, 26, and high dielectric member 27 have the same surface sizes as those of the antenna element 3, ground 4, connection portions 5, 6, and high dielectric member 7 of the first embodiment. Therefore, when a high frequency electric power is fed to the feeding portion 23b, the high frequency electric current applied to the feeding portion 23b flows along parabola portions 23c, 23d, turns back at turnback portions 23e, 23f, and returns to the ground 24 via the connection portions 25, 26 while forming two current loops.

Thus, in the third embodiment, similar to the first and second embodiments, the antenna apparatus 21 can be provided to achieve a wideband characteristic and a wideband wireless communications system with a high data transmission rate. This also provides an effect to decrease a wavelength to allow reductions in sizes of the ground 24 and the antenna apparatus 21 itself.

### Fourth Embodiment

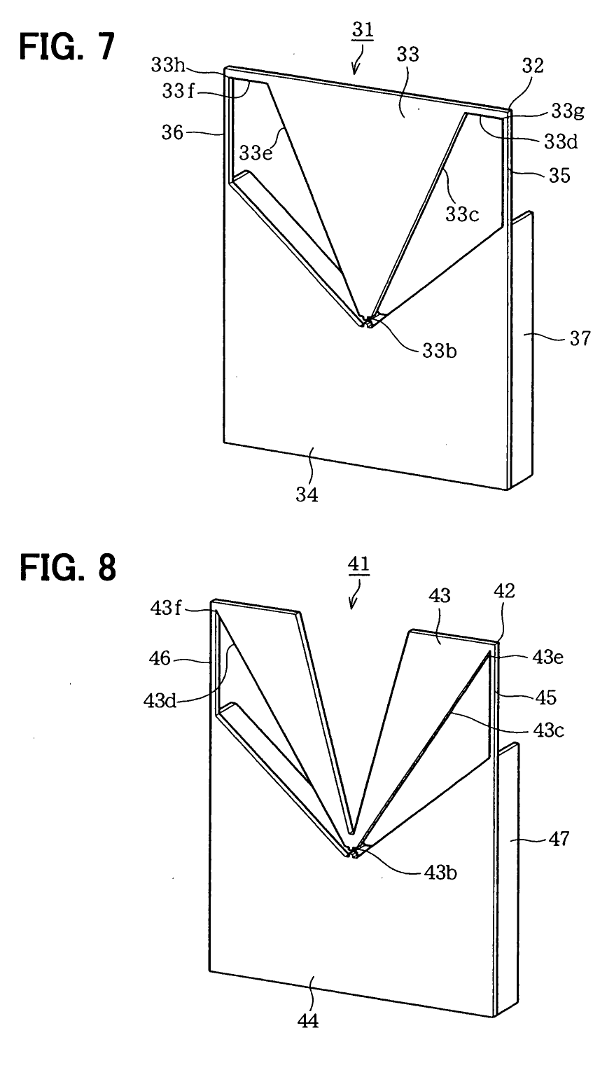

A fourth embodiment of the present invention will be explained with reference to FIG. 7. Parts identical to those of the third embodiment are not explained; different part will be explained below. In the fourth embodiment, an antenna element, a ground, connection portions, high dielectric member have surface sizes different from those in the third embodiment, such that an antenna element has a surface shaped of an inverse triangle. In an antenna apparatus 31, a conductive plate 32 is provided to have two cut areas to thereby form an antenna element 33 in an upper portion, a ground 34 in a lower portion, and connection portions 35, 36 along two lateral ends. Further, a high dielectric member 37 is formed to have a predetermined thickness and a surface shaped identically to that of the ground 34 such that the high dielectric member 37 abuts to all the surface of the ground 34.

In this configuration, when a high frequency electric power is fed to a feeding portion 33b, the high frequency electric current applied to the feeding portion 33b flows along linear portions 33c, 33d, 33e, 33f, turns back at turnback portions 33g, 33h, and returns to the ground 34 via the connection portions 35, 36 while forming two current loops. Thus, in the fourth embodiment, similar to the first, second, and third embodiments, the antenna apparatus 31 can be provided to achieve a wideband characteristic and a wideband wireless communications system with a high data transmission rate. This also provides an effect to decrease a wavelength to allow reductions in sized of the ground 34 and the antenna apparatus 31 itself.

### Fifth Embodiment

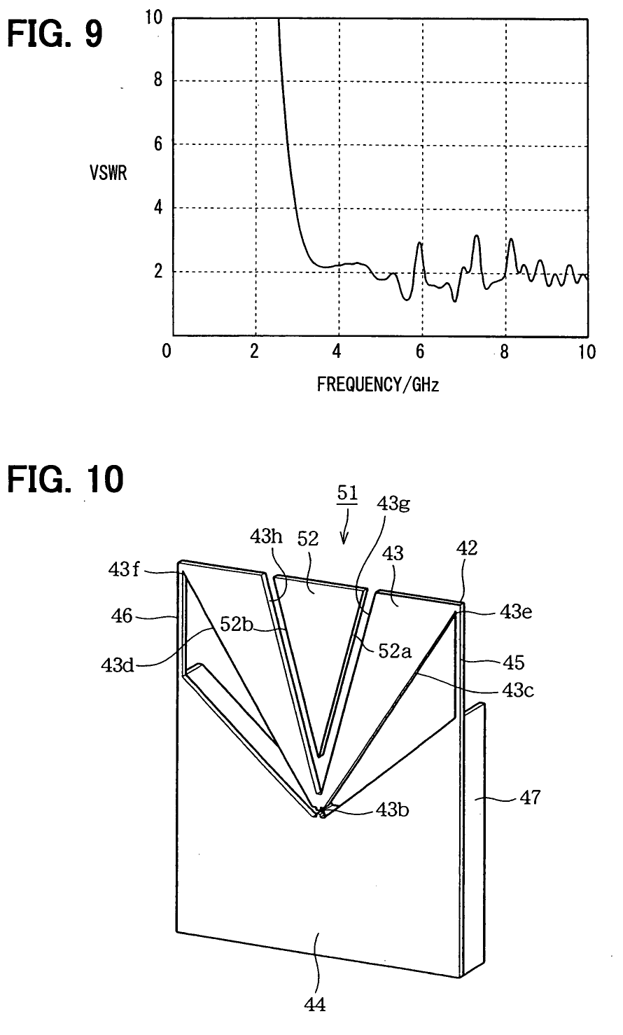

A fifth embodiment of the present invention will be explained with reference to FIGS. 8 and 9. Parts identical to those of the fourth embodiment are not explained; different part will be explained below. In the fifth embodiment, an antenna element has a surface size different from that in the fourth embodiment, such that an antenna element has a cut area shaped of V-letter. In an antenna apparatus 41, a rectangular conductive plate 42 is provided to have three cut areas to thereby form an antenna element 43 in an upper portion, a ground 44 in a lower portion, and connection portions 45, 46 along two lateral ends. Further, a high dielectric member 47 is formed to have a predetermined thickness and a surface shaped identically to that of the ground 44 such that the high dielectric member 47 abuts to all the surface of the ground 44.

In this configuration, when a high frequency electric power is fed to the feeding portion 43b, the high frequency electric current applied to a feeding portion 43b flows along linear portions 43c, 43d, turns back at turnback portions 43e, 43f, and returns to the ground 44 via the connection portions 45, 46 while forming two current loops. FIG. 9 shows measurement results on VSWR (Voltage Standing Wave Ratio) of the antenna apparatus 41, exhibiting a preferable characteristic in 3.1 GHz or more, which is used for communications, similar to the first embodiment. Thus, in the fifth embodiment, similar to the first, second, third, and fourth embodiments, the antenna apparatus 41 can be provided to achieve a wideband characteristic and a wideband wireless communications system with a high data transmission rate. This also provides an effect to decrease a wavelength to allow reductions in sizes of the ground 44 and the antenna apparatus 41 itself.

### Sixth Embodiment

A sixth embodiment of the present invention will be explained with reference to FIG. 10. Parts identical to those of the fifth embodiment are not explained; different part will be explained below. In the sixth embodiment, a parasitic element is provided to adjoin an antenna element in comparison with the fifth embodiment. In an antenna apparatus 51, a parasitic element 52 is arranged using a supporting member (not shown) in an area corresponding to the V-letter cut area of the antenna element 43 in the fifth embodiment.

In this configuration, when a high frequency electric power is fed to the feeding portion 43b, the high frequency electric current applied to the feeding portion 43b flows along the linear portions 43c, 43d, turns back at the turnback portions 43e, 43f, and returns to the ground 44 via the connection portions 45, 46 while forming two current loops.

Here, since linear portions 43g, 43h of the antenna element 43 are approximately parallel with linear portions 52a, 52b of the parasitic element 52, the parasitic element 52 affects the high frequency electric current returning from the antenna element 43 to the ground 44 while forming two loops.

Thus, in the sixth embodiment, similar to the first to fifth embodiments, the antenna apparatus 41 can be provided to achieve a wideband characteristic and a wideband wireless communications system with a high data transmission rate. This also provides an effect to decrease a wavelength to allow reductions in sized of the ground 44 and the antenna apparatus 41 itself.

In particular, in the sixth embodiment, since the parasitic element 52 is close to the antenna element 43, adjustment of the parasitic element 52 in respect to the shape, size, layout, or the like, allows easy adjustment for resonance frequencies, i.e., antenna characteristics.

### Seventh Embodiment

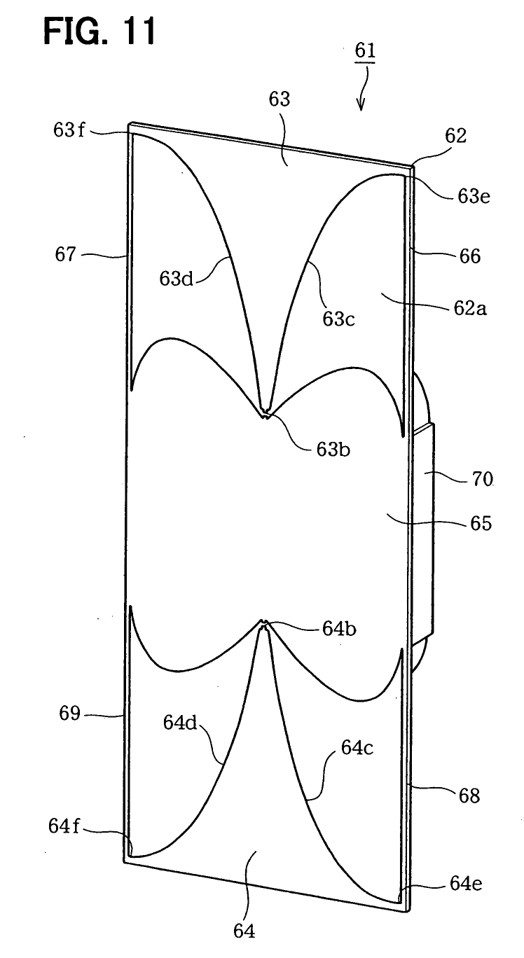

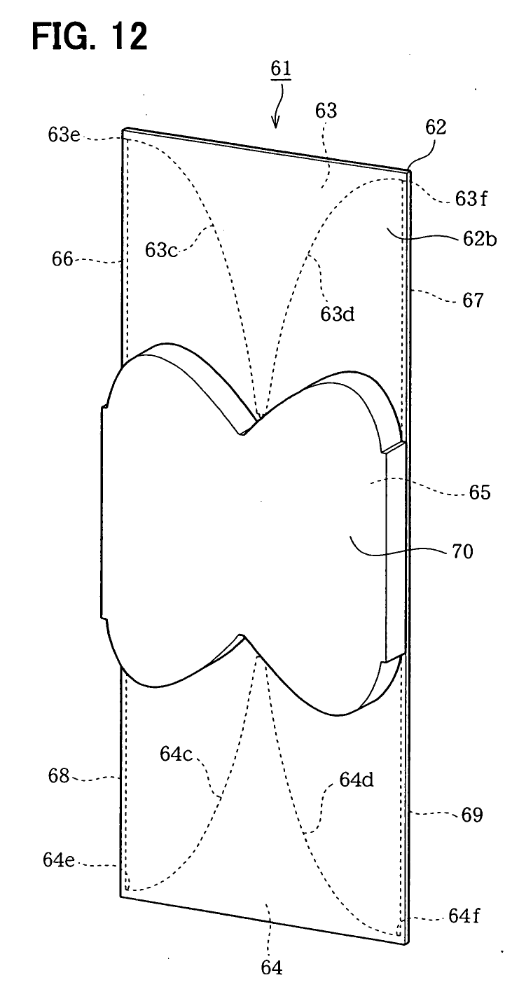

A seventh embodiment of the present invention will be explained with reference to FIGS. 11, 12.

Parts identical to those of the first embodiment are not explained; different part will be explained below.

In the seventh embodiment, an antenna apparatus is provided to be approximately equivalent to a combination of two antenna apparatuses 1 according to the first embodiment.

An antenna apparatus 61 includes a dielectric substrate 62. On the front side 62a of the substrate 62, antenna elements 63, 64 are formed in an upper and lower portions, a ground 65 is formed in a longitudinally central portion, and connection portions 66 to 69 are formed along the left and right ends. Those are formed using copper foil patterns.

In contrast, on the rear side 62b of the dielectric substrate 62, a high dielectric member 70 is formed to have a predetermined thickness and a surface shaped identically to that of the ground 65 such that the high dielectric member 70 and the ground 65 oppose each other face-to-face to sandwich the dielectric substrate 62 therebetween. Here, the antenna elements 63, 64 and ground 65 are arranged to allow diversity reception.

In this configuration, a high frequency electric power is fed to feeding portions 63b, 64b. Here, the high frequency electric current applied to the feeding portion 63b flows along parabola portions 63c, 63d, turns back at turnback portions 63e, 63f, and returns to the ground 65 via the connection portions 66, 67 while forming two current loops. In contrast, the high frequency electric current applied to the feeding portion 64b flows along parabola portions 64c, 64d, turns back at turnback portions 64e, 64f, and returns to the ground 65 via the connection portions 68, 69 while forming two current loops.

Thus, in the seventh embodiment, similar to the first to sixth embodiments, the antenna apparatus 61 can be provided to achieve a wideband characteristic and a wideband wireless communications system with a high data transmission rate. This also provides an effect to decrease a wavelength to allow reductions in sizes of the ground 65 and the antenna apparatus 61 itself.

In particular, both (i) a first pair of the antenna element 63 and ground 65 and (ii) a second pair of the antenna element 64 and ground 65 are arranged to allow diversity reception. This can enhance the antenna characteristic.

### Eighth Embodiment

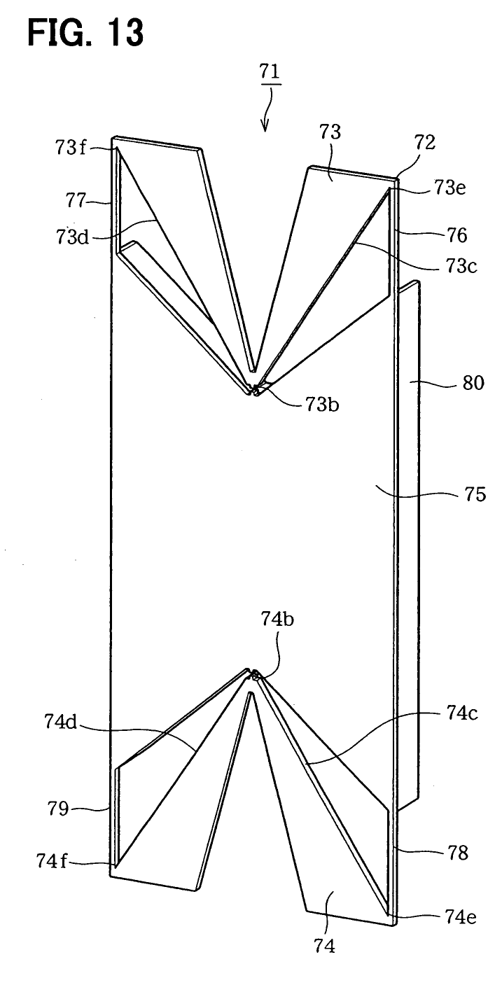

An eighth embodiment of the present invention will be explained with reference to FIG. 13. Parts identical to those of the fifth embodiment are not explained; different part will be explained below. In the eighth embodiment, an antenna apparatus is provided to be approximately equivalent to a combination of two antenna apparatuses 41 according to the fifth embodiment. In an antenna apparatus 71, a rectangular conductive plate 72 is provided to have six cut areas to thereby form antenna elements 73, 74 in an upper and lower portions, a ground 75 in a longitudinally central portion, and connection portions 76 to 79 along two lateral ends. Further, a high dielectric member 80 is formed to have a predetermined thickness and a surface shaped identically to that of the ground 75 such that the high dielectric member 80 abuts to all the surface of the ground 75. Here, the antenna elements 73, 74 and ground 75 are arranged to allow diversity reception.

In this configuration, a high frequency electric power is fed to feeding portions 73b, 74b. Here, the high frequency electric current applied to the feeding portion 73b flows along linear portions 73c, 73d, turns back at turnback portions 73e, 73f, and returns to the ground 75 via the connection portions 76, 77 while forming two current loops. In contrast, the high frequency electric current applied to the feeding portion 74b flows along linear portions 74c, 74d, turns back at turnback portions 74e, 74f, and returns to the ground 75 via the connection portions 78, 79 while forming two current loops.

Thus, in the eighth embodiment, similar to the first to seventh embodiments, the antenna apparatus 71 can be provided to achieve a wideband characteristic and a wideband wireless communications system with a high data transmission rate. This also provides an effect to decrease a wavelength to allow reductions in sizes of the ground 75 and the antenna apparatus 71 itself. Like in the seventh embodiment, in particular, two pairs of the antenna elements 73, 74 and ground 75 are arranged to allow diversity reception. This can enhance the antenna characteristic.

(Others)

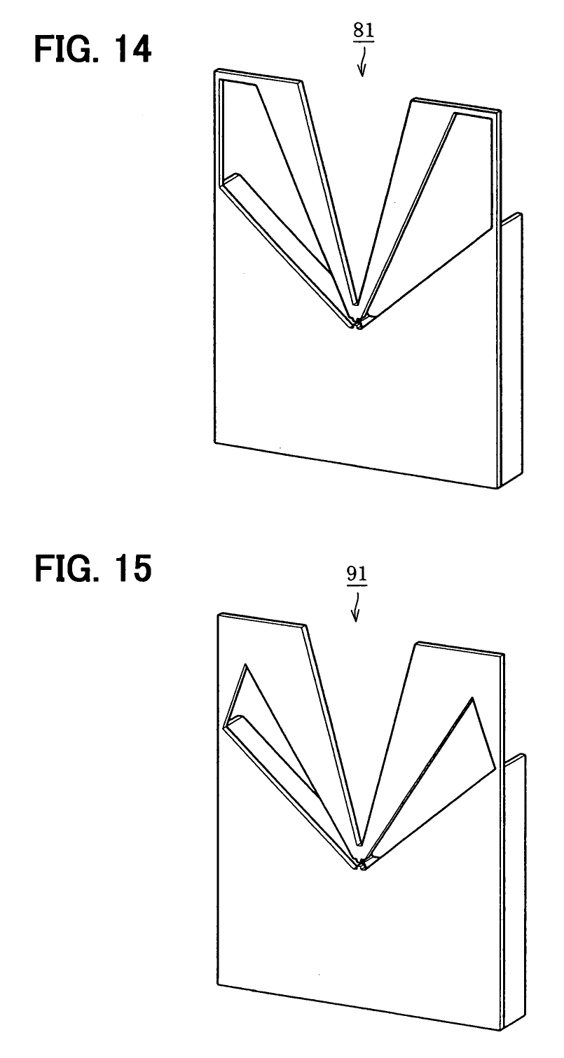

As shown in FIGS. 14, 15, an antenna apparatus 81, 91 can include an antenna element and a ground in other shapes. Further, a high dielectric member may be removed from an antenna apparatus.

It will be obvious to those skilled in the art that various changes may be made in the above-described embodiments of the present invention. However, the scope of the present invention should be determined by the following claims.

What is claimed is:

1. An antenna apparatus comprising:
a ground shaped of a flat plate; and
an antenna element shaped of a flat plate, wherein a surface of the ground and a surface of the antenna element are approximately on a plane, the antenna element including a feeding portion and at least two turnback portions, the at least two turnback portions which are on different radial lines, which originate from the feeding point to depart from each other on the surface of the antenna element,
wherein the at least two turnback portions are individually coupled with the ground via connection portions to thereby form at least two loops, which individually link the feeding portion with the ground.

2. The antenna apparatus of claim 1, further comprising:
a high dielectric member having a predetermined thickness and a surface, which is parallel with the plane and has a shape approximately identical to a shape of the surface of the ground, so that the high dielectric member is configured to oppose the ground face-to-face.

3. The antenna apparatus of claim 1, further comprising:
a dielectric substrate, wherein
each of the antenna element and the ground is made of a conductor pattern provided on the dielectric substrate.

4. The antenna apparatus of claim 1, wherein
each of the antenna element and the ground is made of a conductive plate.

5. The antenna apparatus of claim 1, further comprising:
a parasitic element adjacent to the antenna element.

6. The antenna apparatus of claim 1, further comprising:
an additional antenna element shaped of a flat plate and having a surface, which is approximately on the plane and has a shape approximately identical to a shape of the surface of the antenna element, the additional antenna element including an additional feeding portion and at least two additional turnback portions, the at least two additional turnback portions which are on different radial lines, which originate from the additional feeding point to depart from each other on the surface of the additional antenna element,
wherein the at least two additional turnback portions are individually coupled with the ground via additional connection portions to thereby form at least two additional loops, which individually link the additional feeding point with the ground, and
wherein a first pair of the antenna element and the ground and a second pair of the additional antenna element and the ground are arranged to allow a diversity reception.

7. An antenna apparatus comprising:
a ground shaped of a flat plate;
an antenna element shaped of a flat plate, wherein a surface of the ground and a surface of the antenna element are approximately on a plane, the antenna element including a feeding portion and at least two turnback portions, the at least two turnback portions which are on different radial lines, which originate from the feeding point to depart from each other on the surface of the antenna element, wherein the at least two turnback portions are individually coupled with the ground via connection portions to thereby form at least two loops, which individually link the feeding portion with the ground; and
a high dielectric member having a predetermined thickness and a surface, which is parallel with the plane and has a shape approximately identical to a shape of the surface of the ground, so that the high dielectric member is configured to oppose the ground face-to-face.

8. The antenna apparatus of claim 7, further comprising:
a dielectric substrate, wherein
each of the antenna element and the ground is made of a conductor pattern provided on the dielectric substrate.

9. The antenna apparatus of claim 7, wherein
each of the antenna element and the ground is made of a conductive plate.

10. The antenna apparatus of claim 7, further comprising:
a parasitic element adjacent to the antenna element.

11. The antenna apparatus of claim 7, further comprising:
an additional antenna element shaped of a flat plate and having a surface, which is approximately on the plane and has a shape approximately identical to a shape of the surface of the antenna element, the additional antenna element including an additional feeding portion and at least two additional turnback portions, the at least two additional turnback portions which are on different radial lines, which originate from the additional feeding point to depart from each other on the surface of the additional antenna element,
wherein the at least two additional turnback portions are individually coupled with the ground via additional connection portions to thereby form at least two additional loops, which individually link the additional feeding point with the ground, and
wherein a first pair of the antenna element and the ground and a second pair of the additional antenna element and the ground are arranged to allow a diversity reception.
